(19) United States
(12) Patent Application Publication
(10) Pub. No.: US 2014/0236969 A1
(43) Pub. Date: Aug. 21, 2014

(54) APPARATUS AND METHOD FOR RECOMMENDING CONTENTS BASED ON METADATA GRAPH

(71) Applicant: Electronics and Telecommunications Research Institute, Daejeon-si (KR)

(72) Inventors: Goong-Hyun NAM, Daejeon-si (KR); Kang-Yong LEE, Daejeon-si (KR); Cho-Rong YU, Daejeon-si (KR); Kee-Seong CHO, Daejeon-si (KR)

(73) Assignee: Electronics and Telecommunications Research Institute, Daejeon-si (KR)

(21) Appl. No.: 13/931,014

(22) Filed: Jun. 28, 2013

(30) Foreign Application Priority Data
Feb. 18, 2013 (KR) 10-2013-0017077

(51) Int. Cl. H04N 21/466; G06F 17/30; H04N 21/442

(52) U.S. Cl. CPC H04N 21/4668; H04N 21/44222; G06F 17/30828
USPC 707/749

(57) ABSTRACT

An apparatus and method for recommending contents based on a metadata graph are provided. The apparatus includes a contents metadata acquirer configured to acquire metadata of contents, a contents-related data acquirer configured to acquire contents-related data from the Web, a metadata graph generator configured to analyze acquired contents metadata and contents-related data to generate a metadata graph, a metadata graph DB configured to store a metadata graph generated by the metadata graph generator, and a contents recommender configured to search for contents that are similar to specific contents viewed by a user through a contents output terminal using the metadata graph stored in the metadata graph DB, and recommend the searched contents to the user through the contents output terminal.

### CROSS-REFERENCE TO RELATED APPLICATION

This application claims the benefit under 35 U.S.C. §119(a) of Korean Patent Application No. 10-2013-0017077, filed on Feb. 18, 2013, in the Korean Intellectual Property Office, the entire disclosure of which is incorporated herein by reference for all purposes.

### BACKGROUND

1. Field

The following description relates to a multimedia contents providing apparatus and method, and more particularly, to an apparatus and method for recommending multimedia contents suitable for a user among various multimedia contents.

2. Description of the Related Art

Recently, multimedia devices for receiving and reproducing multimedia contents (hereinafter referred to as ‘contents’) are undergoing diversification and being equipped with multiple functions. As a result, they are enabling users to receive and view contents anywhere at any time.

Moreover, with this diversification and functional enhancement of multimedia devices, different kinds of services that provide contents, and service providers, are increasing in number.

Due to this increase in the amount of contents being provided, it is difficult for a user to check in detail and view information on contents, and a user can merely collect information on contents with a personal computer (PC) or a telephone.

To solve such problems related to contents, an electronic program guide (EPG) service that provides a variety of information about contents has been commercialized, but it has a problem in that it only provides some objective information on contents and excludes the detailed, frank, and subjective opinions of users who have already viewed the contents. Also, services that provide opinions, criticisms, or the like, of experts in contents have been commercialized, but they have low reliability because they only provide the opinions of some experts. For this reason, a scheme is needed in which a user can more easily and simply select contents from among a plurality of contents and moreover select contents with higher reliability.

To meet this demand, services for recommending contents have been developed. They operate according to a method of utilizing consumption history of a plurality of users at a specific time to provide users with contents of a similar type. That is, the services for recommending contents predict consumption of a user to be currently provided with service on the basis of the consumption history of existing users to provide the recommendation service.

However, such consumption history-based recommendation services merely reflect the consumption tendencies of a plurality of users, and cannot provide a user with personalized service. Also, the recommendation services cannot appropriately provide contents that have low or zero consumption rates and thus are unable to accumulate a consumption history.

### SUMMARY

The following description relates to an apparatus and method for providing a personalized multimedia contents recommendation service.

In one general aspect, an apparatus for recommending contents based on a metadata graph includes: a contents metadata acquirer configured to acquire metadata of contents; a contents-related data acquirer configured to acquire contents-related data from the Web; a metadata graph generator configured to analyze the acquired contents metadata and the contents-related data to generate a metadata graph; a metadata graph database (DB) configured to store the metadata graph generated by the metadata graph generator; and a contents recommender configured to search for contents that are similar to specific contents viewed by a user through a contents output terminal using the metadata graph stored in the metadata graph DB, and recommend the searched contents to the user through the contents output terminal.

In another general aspect, a method of recommending contents based on a metadata graph includes: acquiring metadata of contents; acquiring contents-related data from the Web; analyzing the acquired contents metadata and the contents-related data to generate a metadata graph; storing the generated metadata graph; searching for contents that are similar to specific contents viewed by a user through a contents output terminal using the stored metadata graph; and recommending the searched contents to the user through the contents output terminal.

Other features and aspects will be apparent from the following detailed description, the drawings, and the claims.

### BRIEF DESCRIPTION OF THE DRAWINGS

FIG. 1 is a block diagram illustrating an apparatus for recommending contents based on a metadata graph according to an embodiment of the present invention.

FIG. 2 is a diagram illustrating an example of a metadata graph.

FIG. 3 is a diagram illustrating an example of a metadata graph reflecting feedback.

FIG. 4 is a flowchart for describing a method of recommending contents based on a metadata graph according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings.

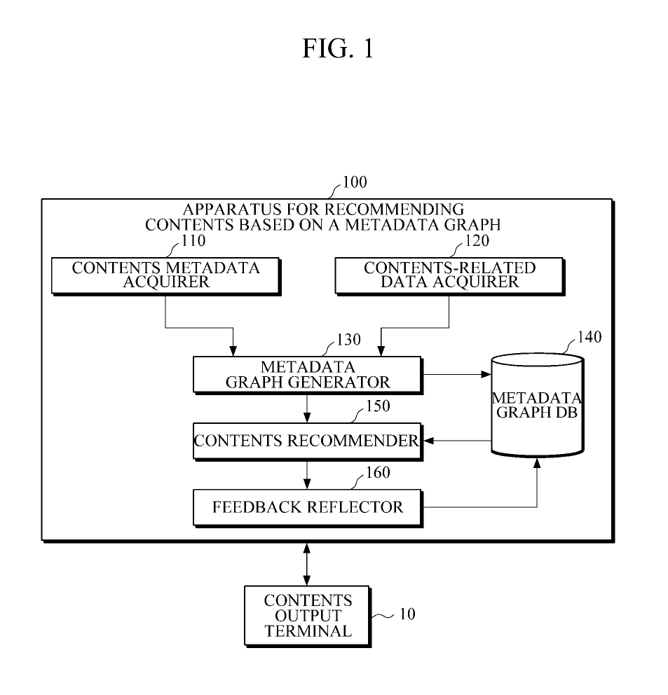

FIG. 1 is a block diagram illustrating an apparatus for recommending contents based on a metadata graph according to an embodiment of the present invention.

Referring to FIG. 1, a contents output terminal 10 is a terminal that outputs a contents service provided by a service provider, and for example, may be a terminal that includes a memory, a microprocessor, and an operational ability like mobile phones, smart phones, notebook computers, digital broadcast terminals, personal digital assistants (PDAs), portable multimedia players (PMPs), and navigations (vehicle navigation apparatuses), in addition to televisions (TVs) and IPTVs. Also, the contents output terminal 10 may be configured as a type that is built into a metadata graph-based contents recommendation apparatus 100.

The metadata graph-based contents recommendation apparatus 100 (hereinafter referred to as a ‘recommendation apparatus’) is an apparatus for providing a contents service to one or more contents output terminals 10, and recommends contents suitable for a viewing history of the contents output terminal 10 according to an embodiment of the present invention. However, technology for providing the contents service is not the central subject matter of the present invention, and thus, a function of recommending contents will be described below.

The recommendation apparatus 100 includes, in detail, a contents metadata acquirer 110, a contents-related data acquirer 120, a metadata graph generator 130, a metadata graph database (DB) 140, a contents recommender 150, and a feedback reflector 160.

The contents metadata acquirer 110 acquires metadata of contents. Here, the metadata may express all attributes of structured data and unstructured data. The structured data are data having a structured form corresponding to the purpose of contents, and may include information on a contents provider, cast members, and a broadcasting station. The unstructured data are data having no specific attributes or form, and may include a program explanation, a program comment, and a related keyword.

Moreover, the contents metadata acquirer 110 selects important data from collected unstructured data and structured data to compose metadata. According to the embodiment, since there is much redundant data in the unstructured data, processing is performed such that a large amount of overlapping data are not generated by extraction/summarization which disallows data to overlap.

The contents-related data acquirer 120 acquires contents-related data from the Web. For example, in a case of contents called ‘Friends’, the contents-related data acquirer 120 may acquire information on main cast members (for example, Matthew Perry, Matt LeBlanc, etc.), contents type information (for example, NBC, comedy, and sitcom), and keywords (for example, ‘Smelly Cat’, ‘The Central Perk coffee house’, and ‘I'll be there for you’) of a main broadcast as relevant data.

The metadata graph generator 130 analyzes the acquired contents metadata and contents-related data to generate a metadata graph.

In the metadata graph, contents and contents-related values are expressed as nodes, and a relationship between the contents and the contents-related values is expressed as an edge. In addition, a correlation between different contents is calculated as a distance between nodes.

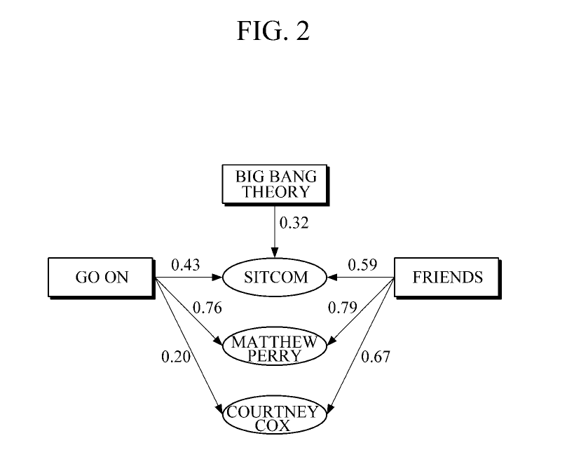

FIG. 2 is a diagram illustrating an example of a metadata graph.

Referring to FIG. 2, a relationship between contents (illustrated as rectangular blocks) and relevant data (illustrated as elliptical blocks) is expressed in the form of graphs. The relationship between the contents and the relevant data is decided by the contents-related data acquirer 120.

The relationship between the contents and the relevant data is calculated by adding explicit information on structured data and the frequency of mutual appearance in unstructured data. Explicit information such as cast members has a higher weight, and is calculated by adding it to the frequency of mutual appearance in the unstructured data. For example, Friends has an explicit relation such as a cast member in relevant values such as sitcom, Matthew Perry, Courtney Cox, etc., and has a relatively higher relationship with Courtney Cox and Matthew Perry. Also, the frequency of mutual appearance in the unstructured data has a higher relationship with Matthew Perry, who is high in frequency of mutual appearance in a newspaper article and a social network service (SNS), in a relation with Courtney Cox and Matthew Perry.

In structured data, values in metadata are expressed as nodes of a graph, and a relation between contents and a corresponding value is expressed as an edge. In unstructured data, entity names in the unstructured data are expressed as nodes of the graph, and a relation between contents and a corresponding value is expressed as an edge. Also, an entity name recognizer may extract a character, a place, etc. for obtaining values corresponding to nodes of the graph from unstructured metadata.

The metadata graph DB 140 stores a metadata graph generated by the metadata graph generator 130.

As a user views specific contents through the contents output terminal 10, the contents recommender 150 searches for similar contents using the metadata graph stored in the metadata graph DB 140. That is, the contents recommender 150 searches the metadata graph to find contents which are connected to contents viewed by a user through the smallest edge. In this way, an explicit reason for recommendation and a relationship are provided, and thus, personalized recommendation reflecting personal preferences becomes easy. That is, recommendation using the metadata graph is performed by searching for edges from A to B, by adding relationships between all reachable connections from A to B. Also, in a connection configured with two edges, a relationship between connections may be calculated by multiplying a relationship between the two edges.

For example, referring to FIG. 2, a relationship between Friends and Go On may be calculated through an arithmetic operation of “0.43*0.59+0.76*0.79+0.20*0.67”, and a relationship between Friends and Big Bang Theory may be calculated through an arithmetic operation of “0.32*0.59”. That is, the relationship between Friends and Go On is greater than the relationship between Friends and Big Bang Theory. Thus, the contents recommender 150 recommends Go On on contents called Friends.

The recommendation apparatus 100 receives feedback information on a consumption pattern of corresponding contents by the service user receiving the recommendation using the contents output terminal 10

To this end, the feedback reflector 160 downloads a feedback information transmission module that transmits feedback information, acquired by the contents output terminal 10, to the recommendation apparatus 10.

The feedback information includes explicit feedback information indicating a user's direct reaction and preference for the selected contents, and implicit feedback information indicating the user's indirect preference for the contents. The user personally evaluates a preference for the contents to give a weight to the evaluated grade, and thus, the explicit feedback information may be used as data. The grade may be classified into three levels, but classified into three levels or more according to the user's setting. The implicit feedback information includes at least one of information on the frequency of access to the contents, an access time for which the user stays in the contents, and the number of times the user selects the contents as a story board.

The feedback reflector 160 reflects a relationship between a corresponding user and a specific node of the metadata graph in the metadata graph DB 140 using the feedback information. For example, when a time for which a service user views specific contents exceeds a predetermined time, the feedback reflector 160 may increase a relationship between corresponding contents, other nodes directly connected to the contents, and a user. In this case, the user's interest is recorded in units of metadata, and thus, it is expected to enable personalized search.

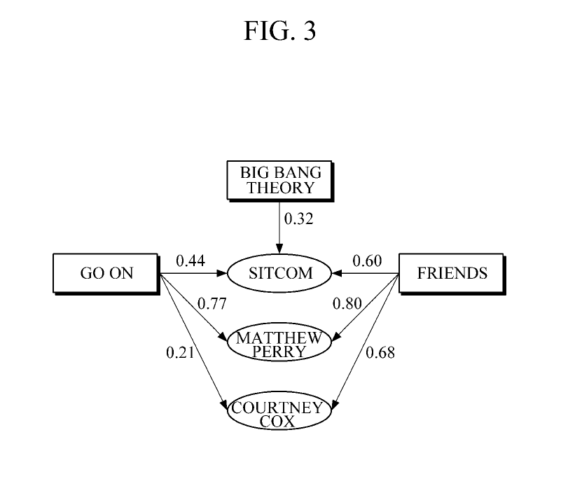

FIG. 3 illustrates an example of a metadata graph reflecting feedback.

When feedback corresponding to satisfaction is received from a user receiving a recommendation according to the metadata graph of FIG. 2, as illustrated in FIG. 3, the feedback reflector 160 increases relationship values of edges used for recommendation. That is, relationship values illustrated as edges connecting Go On and Friends in the metadata graph of FIG. 2 increase by 0.01 each time, as illustrated in FIG. 3.

On the other hand, when negative feedback is received, although not shown, the feedback reflector 160 decreases relationship values of edges used for recommendation.

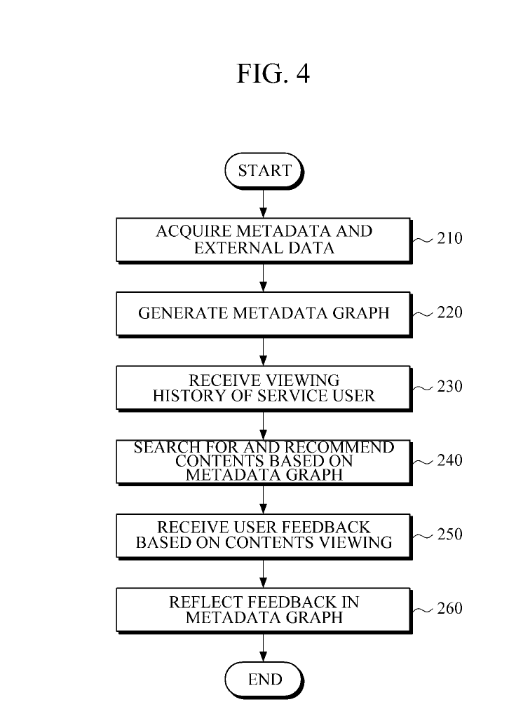

FIG. 4 illustrates an overall flow of a metadata operation according to an embodiment of the present invention.

Referring to FIG. 4, the recommendation apparatus 100 acquires contents metadata and contents-related data from the Web in operation 210.

Here, the metadata may express all attributes of structured data and unstructured data. The structured data are data having a structured form corresponding to the purpose of contents, and may include information on a contents provider, cast members, and a broadcasting station. The unstructured data are data having no specific attribute and form, and may include a program explanation, a program comment, and a related keyword. Also, the recommendation apparatus 100 selects important data from collected unstructured data and structured data to compose metadata. According to the embodiment, since there is much redundant data in the unstructured data, processing is performed such that a large amount of overlapping data are not generated by extraction/summarization which disallows data to overlap.

The recommendation apparatus 100 generates a contents metadata graph in operation 220. In the metadata graph, contents and contents-related values are expressed as nodes, and a relationship between the contents and the contents-related values is expressed as an edge. In addition, a correlation between different contents is calculated as a distance between nodes.

In structured data, values in metadata are expressed as nodes of a graph, and a relation between contents and a corresponding value is expressed as an edge. In unstructured data, entity names in the unstructured data are expressed as nodes of the graph, and a relation between contents and a corresponding value is expressed as an edge. Also, an entity name recognizer may extract a character, a place, etc. for obtaining values corresponding to nodes of the graph from unstructured metadata.

The recommendation apparatus 100 receives a viewing history based on contents viewed by a service user in operation 230.

Then, the recommendation apparatus 100 searches for contents similar to contents which the service user viewed, using the metadata graph, and recommends the searched contents to the service user in operation 240. That is, the recommendation apparatus 100 searches the metadata graph to find contents which are connected to contents viewed by the user through the smallest edge. In this way, an explicit reason for recommendation and a relationship are provided, and thus, personalized recommendation reflecting personal preferences becomes easy.

The recommendation apparatus 100 receives feedback information on a consumption pattern of corresponding contents by the service user receiving the recommendation using the contents output terminal 10, in operation 250.

Subsequently, the recommendation apparatus 100 reflects a relationship between the user and a specific node of the metadata graph using the feedback information in operation 260. For example, when a time for which the service user views specific contents exceeds a predetermined time, the recommendation apparatus 100 may increase a relationship between corresponding contents, other nodes directly connected to the contents, and the user. In this case, the user's interest is recorded in units of metadata, and thus, it is expected to enable personalized search.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for recommending contents based on a metadata graph, comprising:
a contents metadata acquirer configured to acquire metadata of contents;
a contents-related data acquirer configured to acquire contents-related data from the Web;
a metadata graph generator configured to analyze the acquired contents metadata and the contents-related data to generate a metadata graph;
a metadata graph database (DB) configured to store the metadata graph generated by the metadata graph generator; and
a contents recommender configured to search for contents that are similar to specific contents viewed by a user through a contents output terminal using the metadata graph stored in the metadata graph DB, and recommend the searched contents to the user through the contents output terminal.

2. The apparatus of claim 1, wherein the contents metadata acquirer acquires metadata of structured data and unstructured data.

3. The apparatus of claim 1, wherein the metadata graph generator expresses contents and contents-related values as nodes, and expresses a relationship between the contents and the contents-related values as an edge.

4. The apparatus of claim 3, wherein the metadata graph generator calculates a relationship between different contents as a distance between corresponding nodes.

5. The apparatus of claim 3, wherein the contents recommender searches the metadata graph to find contents which are connected to contents viewed by the user through a smallest edge.

6. The apparatus of claim 1, further comprising a feedback reflector configured to acquire consumption pattern feedback information about the service user's consumption of the recommended contents, and reflect the acquired consumption pattern feedback information in the metadata graph.

7. The apparatus of claim 6, wherein when a time for which the service user views contents exceeds a predetermined time, the feedback reflector increases a relationship between corresponding contents, other nodes directly connected to the contents, and the user.

8. A method of recommending contents based on a metadata graph, comprising:
acquiring metadata of contents;
acquiring contents-related data from the Web;
analyzing the acquired contents metadata and the contents-related data to generate a metadata graph;
storing the generated metadata graph;
searching for contents that are similar to specific contents viewed by a user through a contents output terminal using the stored metadata graph; and
recommending the searched contents to the user through the contents output terminal.

9. The method of claim 8, wherein the acquiring of the metadata of contents comprises acquiring metadata of structured data and unstructured data.

10. The method of claim 8, wherein the generating of the metadata graph expresses contents and contents-related values as nodes, and expresses a relationship between the contents and the contents-related values as an edge.

11. The method of claim 10, wherein the generating of the metadata graph comprises calculating a relationship between different contents as a distance between corresponding nodes.

12. The method of claim 10, wherein the recommending of the searched contents comprises searching the metadata graph to find contents which are connected to contents viewed by the user through a smallest edge.

13. The method of claim 8, further comprising acquiring consumption pattern feedback information about the service user's consumption of the recommended contents, and reflecting the acquired consumption pattern feedback information in the metadata graph.

14. The method of claim 8, wherein the reflecting comprises, when a time for which the service user views contents exceeds a predetermined time, increasing a relationship between corresponding contents, other nodes directly connected to the contents, and the user.
